(19) United States
(12) Patent Application Publication
(10) Pub. No.: US 2011/0254204 A1
(43) Pub. Date: Oct. 20, 2011

(54) METHOD OF MODIFYING GLOSS WITH MODIFIED POLYMERS AND RELATED PRODUCTS AND USES

(75) Inventors: Martin Brunner, Wallbach (CH); Gregor Huber, Basel (CH); Laurent Simonpietri, Paris (FR); Michael Tinkl, Gipf-Oberfrick (CH)

(73) Assignee: BASF SE, LUDWIGSHAFEN (DE)

(21) Appl. No.: 13/123,910

(22) PCT Filed: Oct. 21, 2009
(86) PCT No.: PCT/EP2009/063765

§ 371 Date: Jun. 21, 2011

(30) Foreign Application Priority Data
Oct. 31, 2008 (EP) 08168013.4

(51) Int. Cl. B29C 45/00; C08L 55/02; C08L 69/00; C08L 35/06; C08L 51/06; C08L 23/02

(52) U.S. Cl. 264/328.18; 525/74; 525/78; 525/133; 525/207

(57) ABSTRACT

The present invention relates to methods of modulating the gloss of plastics materials and products made from them, such as articles in the automotive industry e.g. for the interior of automobiles, as well as the use of certain additives for that purpose and related invention embodiments. The modulating comprises adding a modified polymer as matting agent to a polymer composition used as polymer substrate for the articles.

The invention relates to the use of (chemically) modified polymers as gloss modulators in polymer products and to corresponding methods and processes, as well as obtainable products.

In short, the present invention also provides a method of modulating, especially reducing the gloss of polymeric compositions comprising adding a modified polymer described in more detail below to polymeric compositions, methods for their manufacture and the corresponding polymeric compositions, as well as products made from these polymeric compositions. Low gloss polymeric compositions formed in accordance with the present invention are suitable for applications where the use of polymers having a matte surface finish is advantageous such as, for example, some automotive (interior) applications.

The technical and environmental advantages of polymers, especially PP (poly(propylene)) and TPO (thermoplastic poly(olefin)), for articles such as automotive interior parts have long been recognized in the automotive market. Most commercial TPO materials for this application have the disadvantage that they must be coated with lacquer or paint or other coatings to provide sufficient scratch resistance and maintain uniform (low) gloss of the final part.

Advanced materials based on PP continue to be popular for automotive interior and exterior components due to major advantages such as low density, convenient processability and good cost/performance balance. The final customers (especially car buyers) continue to increase their quality demands. The (especially car) manufacturers try to meet these demands through improved surface properties, such as scratch resistance, styling harmony, new colours and valuable look, as well as good safety properties, e.g. avoiding disturbing light reflections.

The highest level of interest for interior applications are seen in instrument panel structures, consoles, other interior trim parts, instrument panels as such and door panel skins, but also seat components, handles, cargo liners, engine compartment components or the like. Also in other fields corresponding materials are of interest, e.g. for machine housings, appliances, consumer or electronic devices, outdoor vehicles and devices or any other parts or (e.g. fibre or film) articles needing good mechanical strength and favourable optics, such as low gloss.

The main polymer substrates, for which low gloss and improved scratch resistance remain an unrealized need, are substrates like talc-filled PP copolymer or PP based TPE (skin). As the composition of these materials can vary in a wide range, it is clear, that low gloss and scratch resistance depends on the resin used, the type and content of elastomer and talc, stabilizers and co-additives as well as pigments and other fillers. In addition also the processing conditions and the surface texture (grain) play an important role.

These new materials are intended to be used without any coatings and may be used for both positive (grained during skin fabrication) and negative (grained in the mould tooling) forming process.

To achieve low gloss, additional filler materials have been used. In many applications, however, these types of fillers tend to impair the mechanical properties of the resultant article, while also not consistently providing a uniform finish. Low gloss may also be achieved through the use of an appropriate surface texture on the injection moulding tool. However, maintaining very low gloss over time in production require frequent surface cleaning/re-texturing, which can be expensive and labour intensive.

While coatings have been used to modify the surfaces of corresponding products, it would in principle be desirable to rather have the bulk material as such being exposed at the surface, as then a scratch would not necessarily mean a deterioration of the surface appearance (the same material still being on the surface) and then it is possible to use fewer steps in manufacturing (e.g. without addition of films which may in addition require one or more additional layers, e.g. as adhesives or the like, drying steps, e.g. for coatings, or the like).

Thus, a need exists to find further polymer compositions that allow for the manufacture of products as mentioned without requiring additional coatings or surface treatments. Especially desirable are compositions allowing with low gloss properties while maintaining other important properties such as scratch resistance and mechanical properties, e.g. tensile modulus, tensile stress at break, tensile strain at break and impact resistance.

Especially, the need for improved scratch resistance polymers, especially TPOs, with low gloss used in automotive applications is well known. The highest level of interest for automotive interior applications are seen in instrument panel structures, consoles, other interior trim parts, instrument panel itself and door panel skins.

Low gloss surfaces of the automotive interior are needed especially for two reasons: a) Safety, e.g. lower reflection from the dashboard on to the windshield. b) Design and aesthetics: low gloss surfaces are perceived as higher quality and higher value parts.

The main polymer substrates (meaning basis materials for articles), for which low gloss and improved scratch resistance remain an unrealized need, are substrates like talc-filled PP copolymer or PP based TPE (skin). As the composition of these materials can vary in a wide range, it is clear that low gloss and scratch resistance depends on the resin used, the type and content of elastomer and talc, stabilizers and co-additives as well as pigments and other fillers. In addition also the processing conditions and the surface texture (grain) play an important role.

These new materials are intended to be used (at least preferably) without any coatings and may be used for both positive (grained during skin fabrication) and negative (grained in the mould tooling) forming process.

It has now surprisingly been found that the addition of certain modified polymers, especially (at least partially) esterified forms of polymers having carboxyl groups (—COOH) in their backbones, or graft polymers obtainable by the reaction of an unsaturated carbonic acid, an ester thereof and/or a vinyl aromatic compound with the backbone polymer, to the polymer compositions (especially a PP or a TPO) allow to achieve the desirable gloss properties while substantially maintaining or even improving the other important properties, e.g. those just mentioned.

The present invention thus, in a first aspect, provides a method of modulating, especially reducing the gloss of polymeric compositions. Low gloss polymeric compositions formed in accordance with the present invention are suitable for applications where the use of polymers having a matte surface finish is advantageous such as, for example, some automotive (interior) applications.

The polymeric compositions formed in accordance with the present invention exhibit improved (especially low) gloss characteristics and good or even improved physical properties.

Generally, the low gloss compositions are formed by melt mixing of polypropylene compositions with (chemically) modified polymers according to the invention.

Fillers such as talc and wollastonite and other processing additives may also be included in the compositions according to the invention. Other customary additives in the polymer field may be present as well.

The present invention thus especially includes a method or process for modulating, especially reducing (lowering), the gloss of a polymer article (the term article including herein a flat product such as a film or a skin, or a three-dimensional product) and/or for producing a low gloss polymer article, comprising adding (especially by melt mixing) to the bulk starting polymer mixture a modified polymer as defined above and in more detail below to modulate, especially reduce (lower), the gloss (in comparison to an otherwise identical mixture which, however, lacks the addition of the melamine derivative) and then forming the article, or the use of a modified polymer as defined above and in more detail below as additive to reduce gloss of a polymer article by adding it to the mixture used for forming said polymer article. Preferably, an amount of a modified is added that is effective in lowering the gloss in comparison to the composition lacking said modified polymer (but which is otherwise identical).

Preferably, also the conditions of the manufacture of the polymer article to be produced are chosen so that the addition of a modified polymer as defined above and in more detail below to modulate, especially the amount and/or the type of such a modified polymer, in combination with the chosen process conditions leads to a lowering of gloss compared to an article that has an otherwise identical composition but that lacks the modified polymer.

Where the term “modulating” the gloss is used in the present specification, this is also intended to mean that the gloss may be adapted to a desired value, that is, in principle it is also possible that the gloss is enlarged. In one embodiment of all invention embodiments described herein, the term is especially used for “reducing” (lowering) the gloss.

The thermoplastic resin composition according to the present invention can be formed into a variety of articles by known methods such as thermoforming, extrusion, processing of fibrous substrates, sheet forming, or especially moulding, e.g. extrusion moulding, vacuum moulding, profile moulding, foam moulding, injection moulding, blow moulding, compression moulding, rotational moulding, or the like.

The present invention also relates to the use of a modified polymer as defined above and in more detail below to modulate as gloss diminishing agent, whereby the modified polymer is added to a mixture used for forming a polymer article.

Generally, for each embodiment of the invention 1, 2 or more up to all more general terms within the present disclosure may be replaced by more specific definitions given hereinbefore and hereinafter to give further advantageous embodiments of the invention.

Where the indefinite article “a” or “an” is used, this is intended to include “at least one”, e.g. “one or more”.

The polymeric compositions formed in accordance with the present invention exhibit improved low gloss characteristics and improved physical properties.

Generally, the low gloss compositions are formed conveniently by melt mixing of the polymer substrate, such as polypropylene compositions, with the (chemically) modified polymers as additives covered in this invention.

Fillers such as talc and wollastonite and other processing additives may also be included in the compositions according to the invention.

The present invention relates to especially commercially available modified polymers. These products are described according to the invention to be useful and used as surface modifier, especially as low gloss additives in PP/TPO polymer compositions and products for automotive applications.

The modified polymers according to the invention are preferably selected from the group consisting of (at least partially) esterified forms of polymers (at least before the esterification) having carboxyl groups (—COOH) in their backbones, and graft polymers obtainable by the reaction of an unsaturated carbonic acid, an ester thereof and/or a vinyl aromatic compound with the backbone polymer, or mixtures of two or more of these modified polymers.

In the case of an at least partially esterified form of polymer, backbones (polymer substrates) appropriate for modified polymers according to the invention are especially copolymerisates of styrene or a styrene derivative, such as styrene substituted with a C₁-C₆ alkyl, either alpha-substituted, e.g. alpha-methyl styrene, or substituted on the aromatic ring, e.g. vinyl toluene, or a mixture of such styrene and/or substituted styrenes, especially styrene, and maleic acid or a C₁-C₃-mono- or di-alkyl substituted and/or aryl (e.g. C₆-C₁₂-aryl) substituted maleic acid, such as 2-methyl maleic acid, 2-ethyl maleic acid, 2-phenyl maleic acid and 2,3-dimethyl maleic acid (the reaction preferably being conducted with a reactive acid derivative thereof, e.g. an anhydride). For the at least partial esterification, the (if required after a further hydrolysis) thus obtained backbones are then esterified at least part of their carboxyls with at least a major alcohol, e.g. a sec.-butyl alcohol, such as sec.-butyl alcohol or a derivative, or an alcohol selected from a different alkyl (e.g. C₁-C₂₀), aryl (e.g. C₆-C₁₂), cycloalkyl (e.g. C₃-C₁₀), arylalkyl (e.g. with aryl and alkyl as just defined) or alkylaryl (with aryl and alkyl as just defined) monoalcohol, such as 3-cyclohexyl-1-propanol, cyclohexylmethanol, phenylethyl alcohol, methyl cyclohexanol and 2-ethyl-1-hexanol, alone or followed by a second minor alcohol, e.g. methanol, ethanol or n-propanol. The esterification for the manufacture of these modified polymers preferably follows the method or a method analogous to the method described in U.S. Pat. No. 5,773,518, which is here incorporated by reference for this purpose. An especially preferred modified polymer for use according to the invention of this type is known under the trademark Scripset 550 (or also Scripset 540), and is preferably defined as given below in the Examples.

A graft polymer useful as a modified polymer according to the invention preferably has a backbone selected from the group of a polyene, such as polymers of monoolefins and diolefins, e.g. polypropylene, e.g. High Crystalline polypropylene, polybut-1-ene, poly-4-methylpent-1-ene, polyisoprene or polybutadiene, as well as polymers of cycloolefins, e.g. cyclopenten or norbornene, polyethylene (optionally crosslinked), e.g. high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), VLDPE and ULDPE, or mixtures of two or more of the polymers just mentioned, e.g. mixtures of polypropylene with polyisobutylene, with polyethylene (for example PP/HDPE or PP/LDPE) or mixtures of different types of polyethylene (e.g. LDPE/HDPE), copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexane copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide, as well as polymers of ethylene with propylene and a diene, such as hexadiene, dicyclopentadiene or ethylidene-norbornene; and mixtures of such copolymers with one another or with other polymers mentioned above, for example poly(propylene/ethylene-propylene) copolymers, LDPE/ethylene-vinyl acetate copolymers (EVA), LLDPE/EVA) or the like;

or polymers based on styrene polymerisation alone, such as poly(styrene) (PS), e.g. syndiotactic poly(styrene) (sPS), or HIPS (high impact poly(styrene));
or styrene comprising polymers, such as ABS (acrylonitrile-butadiene-styrene polymers), SBS (styrene-butadiene-styrene triblock copolymers), SAN (styrene-acrylonitrile copolymers), or ASA (acrylonitrile-acrylate elastomer-styrene copolymers, also acrylonitrile-styrene-acrylate), or mixtures of two or more thereof, including polyolefin elastomers, such as ethylene-propylene-diene monomer copolymers (EPDM), copolymers of ethylene with higher alpha-olefins (such as ethylene-octene copolymers), polybutadiene, polyisoprene, styrene-butadiene copolymers, hydrogenated styrene-butadiene copolymers, styrene-isoprene copolymers, hydrogenated styrene-isoprene copolymers and the like (see also below for the definition of TPOs).

These backbones are grafted (and thus modified) with an unsaturated carbonic acid, e.g. an unsaturated monocarboxylic acid, such as acrylic acid, methycrylic acid or cyanoacrylic acid, or an unsaturated di-carboxylic acid, such as maleic acid or a C₁-C₃-mono- or -di-substituted or aryl (e.g. C₆-C₁₂-aryl) substituted maleic acid, such as 2-methyl maleic acid, 2-ethyl-maleic acid, 2-phenyl-maleic acid, or 2,3-dimethyl maleic acid, fumaric acid, or a reactive precursor form thereof, such as an anhydride, where the grafting may also take place with more than one of these monomers. The grafting can also take place with an ester of the mentioned mono- or dicarboxylic acids, e.g. an ester with a C₁-C₁₂-alcohol, such as methanol or ethanol, or with a vinyl aromatic compound, especially styrene or a styrene derivative as defined in the preceding paragraph for polystyrene or styrene comprising polymers. Also grafting with two or more monomers selected from the group consisting of an unsaturated carboxylic acid (used throughout synonymously with the term unsaturated carbonic acid), an ester thereof and a vinyl aromatic compound is included in the scope of the present invention.

Especially preferred are the modified graft polymers given in Table 3 in Example 2 (Scona products).

The method of manufacture can, for example and preferably, follow the methods described in or to methods analogous to those described in WO 2004/048426 and/or WO 02/093157, that is, by a solid phase synthesis. These two documents are therefore incorporated by reference herein for the purpose of the manufacturing methods described therein. However, also other known methods known in the art are possible, e.g. melt or solvent methods.

The monomers used for grafting are free of epoxy and fluoro substituents.

The composition used for forming an article according to the invention preferably comprises a modified polymer as described herein in an amount (by weight) of 0.2 to 40%, more preferably from about 0.5 to about 30% or preferably to about 25%, yet more preferably from about 1 to about 18%, e.g. from about 2 to about 10% by weight.

The size of the modified polymer particles can e.g. be in the range from about 0.1 to about 100 μm, e.g. from about 0.2 μm to about 50 μm, such as from about 0.5 μm to about 30 μm (mean size as measured e.g. by electron microscopy—preferably the size distribution is such that more than 50, more preferably more than 75% of the particles (by weight) are within ±50% of the mean value).

Where “about” is used, this is intended to mean that a slight variation (often unavoidable in technical practice) of the numerical value given after “about” is possible, e.g. in the range of ±10%, for example ±3%, of the given value is possible.

Where “an amount of modified polymer is added that is effective in lowering the gloss” is meant, this is especially meant to include an amount that leads to a reduction of gloss of the resulting article when compared with the otherwise identical composition of an article without added modified polymer derivative, e.g. (using the method given in the Examples) to a lowering of the gloss by 2% or more, e.g. by 5% or more, for example by 10 to 99%.

In addition, the process conditions in the methods or uses according to the invention may be modified so as to allow the reduction of gloss in comparison to conditions where no reduction of gloss is possible. Among the parameters that may be modulated are, e.g., the temperature of the melting, the rate of moving the material into the device forming the desired product (e.g. a form for moulding, an extruder, nozzles or the like), the temperature for filling a form for moulding (especially the temperature of the mould before introduction), the temperature of the forming device, the temperature of the processing to the solid product, and the like. The skilled person, based also on the evidence in the Examples, will conveniently be able to devise appropriate process conditions by one or a very limited number of experiments. For example, in the case of forming an article by moulding, the temperature of the mould can be selected in the range from about 20 to about 60° C., e.g. in the range from 20 to 30° C., the temperature of injection can preferably be chosen in the range from 200 to 280° C., e.g. in the range from 200 to 230° C., and the injection speed under the equipment conditions given in the Examples can preferably be chosen in the range from 5 mm/sec to 120 mm/sec, e.g. from about 10 to about 100 mm/sec, at least as a starting point if a further experiment should be required.

The basis material (polymer substrate) for the compositions useful for the low gloss products according to the invention may be selected from any type of polymers or polymer mixtures appropriate for melt mixing. Among the possible polymers, the following may be mentioned paradigmatically: a styrene comprising polymer, such as ABS (acrylonitrile-butadiene-styrene polymers), SBS (styrene-butadiene-styrene triblock copolymers), SAN (styrene-acrylonitrile copolymers), ASA (acrylonitrile-acrylate elastomer-styrene copolymers, also acrylonitrile-styrene-acrylate), a polyester, for example derived from dicarboxylic acids and dialcohols and/or from hydroxycarboxylic acids or the corresponding lactones such as such as PBT (poly(butylene terephthalate), PET (poly(ethylene terephthalate), poly-1,4-dimethylolcyclohexane terephthalate, polyhydroxybenzoates, copolyether ester or UPES (unsaturated polyesters), PA (polyamides, e.g. polyamides derived from diamines and dicarboxylic acids and/or from aminocarboxylic acids or the corresponding lactams, such as polyamide 4, polyamide 6, polyamides 6/6, 6/10, 6/9, 6/12, 4/6, 66/6, 6/66, polyamide 11, polyamide 12, partially aromatic (co)polyamides, for example polyamides based on an aromatic diamine and adipic acid, polyamides prepared from an alkylene diamine and iso- and/or terephthalic acid and copolyamides thereof, copolyether amides, copolyester amides and the like), TPU (thermoplastic elastomers on urethane basis), PS (poly(styrene)), HIPS (high impact poly(styrene)), PC (polycarbonates), as poly(aromatic carbonate)s or poly(aliphatic carbonate)s, e.g. based on bisphenol A and “carbonic acid” units or other bisphenols and/or dicarbonic acid units as comonomers, PC/ABS (polycarbonate/acrylonitrile-butadiene-styrene blend), ABS/PBT (acrylonitrile-butadiene-styrene/poly(butylenes terephthalate) blend), PVC (poly(vinyl chloride)); PVC/ABS (poly(vinyl chloride)/acrylonitrile-butadiene-styrene polymer), PVC/ASA (poly(vinyl chloride)/acrylonbitrile-styrene-acrylate), PVC/acrylate (acrylate-modified PVC) and ionomers (copolymerisates of an ionized (at least partially) and an electrically neutral monomer).

In one preferred example, the polymer substrate is a polyolefin (e.g. High Crystalline PP), PC/ABS, ABS, a polyamide, such as PA-6, or a polyolefin rubber or TPE, or for example a polymer as mentioned specifically in the Examples.

Examples of polyolefins are: Polymers of monoolefins and diolefins, e.g. polypropylene, e.g. High Crystalline polypropylene, polybut-1-ene, poly-4-methylpent-1-ene, polyisoprene or polybutadiene, as well as polymers of cycloolefins, e.g. cyclopenten or norbornene, polyethylene (optionally crosslinked), e.g. high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), VLDPE and ULDPE, or mixtures of two or more of the polymers just mentioned, e.g. mixtures of polypropylene with polyisobutylene, with polyethylene (for example PP/HDPE or PP/LDPE) or mixtures of different types of polyethylene (e.g. LDPE/HDPE), copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexane copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide, as well as polymers of ethylene with propylene and a diene, such as hexadiene, dicyclopentadiene or ethylidene-norbornene; and mixtures of such copolymers with one another or with other polymers mentioned above, for example poly(propylene/ethylene-propylene) copolymers, LDPE/ethylene-vinyl acetate copolymers (EVA), LLDPE/EVA) or the like.

For example, appropriate polyolefins are as described in WO 2006/003127 (Ciba).

Thermoplastic elastomers (TPE) comprise e.g. rubber modified polyolefins are also known as thermoplastic polyolefins (TPO). They are basically blends of the polymers mentioned above as polyolefins with impact modifiers, such as ethylene-propylene-diene monomer copolymers (EPDM), copolymers of ethylene with higher alpha-olefins (such as ethylene-octene copolymers), polybutadiene, polyisoprene, styrene-butadiene copolymers, hydrogenated styrene-butadiene copolymers, styrene-isoprene copolymers, hydrogenated styrene-isoprene copolymers and the like. These blends are commonly referred to as TPOs (thermoplastic polyolefins). For example, an appropriate TPO has from about 10 to about 90 weight percent of propylene homopolymer, copolymer or terpolymer, and about 90 to about 10 weight percent of an elastic copolymer of ethylene and a C₃-C₈-alpha-olefin.

For example, appropriate TPO are disclosed in U.S. Pat. No. 6,048,942 (Montell).

Polyolefins and rubber modified polyolefins may not solely be the polymer substrate of the present compositions. Not excluded as polymer substrates are copolymers of polyolefins with other polymers or blends of polyolefins with other polymers as described above.

Other additives can be present in the polymer compositions with regard to the invention.

The polymer compositions (polymer substrates) of the present invention thus optionally contain from about 0.01 to about 5%, preferably from about 0.025 to about 2%, and especially from about 0.1 to about 1% by weight of various further additives, such as the compounds listed below, and optionally in addition up to 40%, e.g. 0 to 35, for example 10 to 25% of a nucleating agent or filler (such as talcum), or mixtures thereof:

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol) 2,6-di-tert-butyl-4-n-butylphenol, 2,6-di-tert-butyl-4-isobutylphenol, 2,6-dicyclopentyl-4-methylphenol, 2-(oc-methylcyclohexyl)-4,6-di-methylphenol, 2)6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1-methylundec-1-yl)phenol, 2,4-di-methyl-6-(1-methylheptadec-1-yl)phenol, 2,4-dimethyl-6-(1-methyltridec-1-yl)phenol or mixtures of tow or more thereof.

1.2. Alkylthiomethylphenols, for example 2,4-dioctylthiomethyl-6-tert-butylphenol]-2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydrooxyphenyl)adipate.

1.4. Tocopherols.

1.5. Hydroxylated thiodiphenyl ethers.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,21-methylenebis(4-methyl-6-cyclohexylphenol)l 2,2′-methylenebis(6-nonyl-4-methyl phenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methyl phenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′tert-butyl-2-hydroxy-5-methylbenzyl)-6-tert-butyl-4-methylphenyl]terephthalate], 1,1-bis-(3J5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. Benzyl compounds, for example 3,5,3″,5,-tetra-tert-butyl-4-4′-dihydroxydibenzyl ether.

1.8. Hydroxybenzylated malonates.

1.10. Other Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzyl phosphonate, dioctadecyl-3,5-di-tert-butyl-4-hydroxybenzylphosphonate, dioctadecyl-δ-tert-butyl-hydroxy-S-methylbenzylphosphonate, the calcium salt of the monoethyl ester of 3,5-di-tert-butyl-4-hydroxybenzylphosphonic acid.

1.12. Acylaminophenols.

1.13. Esters of β-(3,5-di-tert-butyl-4-hydroxyphenyl)propionic acid with mono- or polyhydric alcohols.

1.14. Esters of β-(5-tert-butyl-4-hydroxy-3-methylphenyl)propionic acid with mono- or poly hydric alcohols.

1.15. Esters of β-(3,5-dicyclohexyl-4-methylphenyl)propionic acid with mono- or polyhydric alcohols.

1.16. Esters of 3,5-di-tert-butyl-4-hydroxyphenyl acetic acid with mono- or polyhydric alcohols.

1.17. Amides of β-(3,5-di-tert-butyl-4-hydroxyphenyl)propionic acid.

1.18. Ascorbic acid (vitamin C).

1.19. Aminic antioxidants.

2. UV absorbers and light stabilizers

2.1. 2-(2-Hydroxyphenyl)-2H-benzotriazoles, for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)-ethylphenyl)-2H-benzotriazole, dodecylated 2-(2-hydroxy-5-methylphenyl)-2H-benzotriazole, 2-(3-tert-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-tert-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzo-triazol-2-yl)phenol), 2-(2-hydroxy-3-oc-cumyl-5-t-octylphenyl)-2H-benzotriazole, 2-(2-hydroxy-3-t-octyl-5-α-cumyl phenyl)-2H-benzotriazole, 5-fluoro-2-(2-hydroxy-3,5-di-α-cumylphenyl)-2 H-benzotriazole, 5-chloro-2-(2-hydroxy-3,5-di-α-cumylphenyl)-2H-benzotriazole, 5-chloro-2-(2-hydroxy-3-a-cumyl-5-t-octylphenyl)-2H-benzo-triazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octyl-phenyl)-2H-benzotriazole, 5-trifluoromethyl-2-(2-hydroxy-3-α-cumyl-5-t-butylphenyl)-2H-benzotriazole, 5-trifluoromethyl-2-(2-hydroxy-3,5-di-t-butylphenyl)-2H-benzotriazole, 5-trifluoromethyl-2-(2-hydroxy-3,5-di-a-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′J41-tri hydroxy and 2l-hydroxy-4,4′-dimethoxy derivatives.

2.3. Esters of substituted and unsubstituted benzoic acids, as for example 4-tert-butyl phenyl salicylate, phenyl salicylate, octyl phenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl-S.S-di-tert-butyl-4-hydroxybenzoate, octadecyl 3,5-di-tert-butyl-4-hydroxybenzoate, 2-methyl-4,6-di-tert-butylphenyl-3,5-di-tert-butyl-4-hydroxybenzoate.

2.4. Acrylates and malonates, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, N-(β-carbomethoxy-β-cyanovinyl)-2-methyl-indoline, Sanduvor® PR25, dimethyl p-methoxybenzylidenemalonate (CAS# 7443-25-6), and Sanduvor® PR31, methylpiperidin-4-yl) p-methoxybenzylidenemalonate (CAS #147783-69-5).

2.5. Nickel compounds, for example nickel complexes of 2,2′-thio-bis-[4-(1,1,3,3-tetramethylbutyl)phenol], nickel dibutyldithiocarbamate, nickel salts of the monoalkyl esters, nickel complexes of ketoximes, or nickel complexes of 1-phenyl-4-lauroyl-5-hydroxypyrazole, with or without additional ligands.

2.6. Sterically hindered amine stabilizers, for example 4-hydroxy-2,2,6,6-tetramethylpiperidine, 1-allyl-4-hydroxy-2,2,6,6-tetramethylpiperidine, 1-benzy-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6J6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4,5]ldecane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyl-oxycarbonyl)-2-(4-methoxyphenyl)ethene], N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

The sterically hindered amine may also be one of the compounds described in U.S. Pat. No. 5,980,783, the relevant parts of which are hereby incorporated by reference, that is compounds of component I-a), I-b), I-c), I-d), I-e), I-f), I-g), I-h), I-i), I-j), I-k) or I-l), in particular the light stabilizer 1-a-1, 1-a-2, 1-b-1, 1-c-1, 1-C-2, 1-d-1, 1-d-2, 1-d-3, 1-e-1, 1-f-1, 1-g-1, 1-g-2 or 1-k-1 listed on columns 64-72 of said U.S. Pat. No. 5,980,783.

The sterically hindered amine may also be one of the compounds described in U.S. Pat. Nos. 6,046,304 and 6,297,299, the disclosures of which are hereby incorporated by reference, for example compounds as described in claims 10 or 38 or in Examples 1-12 or D-1 to D-5 therein.

2.7. Sterically hindered amines substituted on the N-atom by a hydroxy-substituted alkoxy group, for example compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl) sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate and 2,4-bis{N-[1-(2-hydroxy-2-methylpropoxy)-2,2,6,6-tetramethylpiperidin-4-yl]-N-butylamino}-6-(2-hydroxyethylamino)-s-triazine.

2.8. Oxamides.

2.9. Tris-aryl-o-hydroxyphenyl-s-triazines. for example known commercial tris-aryl-o-hydroxyphenyl-s-triazines and triazines as disclosed in, U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,242,598 and 6,255,483, for example 4,6-bis-(2,4-dimethylphenyl)-2-(2-hydroxy-4-octyloxyphenyl)-s-triazine, Cyasorb® 1164, Cytec Corp, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4˜bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxyethoxy)phenyl]-6-(4-bromophenyl)-s-triazine, 2,4-bis[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-tri-azine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy-4-(3-nonyloxy*-2-hydroxypropyloxy)-5-α-cumylphenyl]-s-triazine (* denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylideneoxyphenyl)-s-triazine, 2,4-bis(2,4-dimethylphenyl)-6-(2-hydroxy-4-hexyloxy-5-α-cumylphenyl)-s-triazine, 2-(2,4,6-trimethylphenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-doclecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, Tinuvin® 400, Ciba Specialty Chemicals Corp., 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

3. Metal deactivators.

4. Phosphites and phosphonites, for example triphenyl phosphite, diphenyl alkyl phosphites, phenyl dialkyl phosphites, tris(nonyl phenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-dibenzo[d,f][[1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl)methyl phosphite, bis(2,4-di-tert-butyl-6-methylphenyl)ethyl phosphite, 2,2′,2″-nitrilo[triethyltris(3,3,5,5′-tetra-tert-butyl-1,1″-biphenyl′-2,2″-diyl)phosphite], 2-ethylhexyl(3,3″,5,5-tetra-tert-butyl-1,1′-biphenyl-2,2′-diyl″)phosphite.

5. Hydroxylamines.

6. Nitrones.

7. Amine oxides.

8. Benzofuranones and indolinones.

9. Thiosvnergists.

10. Peroxide scavengers.

11. Polyamide stabilizers.

12. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example, calcium stearate, zinc stearate, magnesium behenate, magnesium stearate, sodium ricinoleate and potassium palmitate, antimony pyrocatecholate or zinc pyrocatecholate.

13. Nucleating agents, for example inorganic substances such as talcum, metal oxides such as titanium dioxide, magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

14. Fillers and reinforcing agents, for example calcium carbonate, silicates, glass fibers, glass bulbs, asbestos, talc, kaolin, mica, barium sulfate, metal oxides and hydroxides, carbon black, graphite, wood flour and flours or fibers of other natural products, synthetic fibers.

15. Dispersing Agents, such as polyethylene oxide waxes or mineral oil.

16. Other additives, for example plasticizers, lubricants, emulsifiers, pigments, dyes, optical brighteners, rheology additives, catalysts, flow-control agents, slip agents, crosslinking agents, crosslinking boosters, halogen scavengers, smoke inhibitors, flameproofing agents, such as melamine phosphate or melamine cyanurate, antistatic agents, clarifiers such as substituted and unsubstituted bisbenzylidene sorbitols, benzoxazinone UV absorbers such as 2,2′-p-phenylene-bis(3,1-benzoxazin-4-one), Cyasorb® 3638 (CAS# 18600-59-4), and/or blowing agents.

Among the preferred further additives are one or more additives selected from the group consisting of hindered amine light (especially UV) stabilizers, hindered phenols, phosphites, benzofuranone stabilizers and hydroxyphenylbenzotriazole, hydroxyphenyl-s-triazine or benzophenone ultraviolet light absorbers, fillers or nucleating agents, such as talcum and carbon black, and basic co-stabilizers, such as calcium stearate, and (with stronger gloss lowering effect) also melamine phosphate or melamine cyanurate, or mixtures of two or more thereof.

Another embodiment of this invention is the use of one or more modified polymers as herein defined as scratch resistance improving agent(s) in polymer composition products as herein described.

The compositions according to the present invention are also useful for other potential markets besides the (though preferred) automotive applications, e.g. for panel structures, consoles, other interior trim parts, instrument panels as such and door panel skins, but also seat components, handles, cargo liners, engine compartment components or the like, are e.g. for machine housings, appliances, consumer or electronic devices, outdoor vehicles and devices or any other parts needing good mechanical strength and favourable optics, such as low gloss, or in the appliances and packaging markets.

The following Examples illustrate the invention without limiting its scope. Where percentages are given (%), this refers to percent by weight (based on the complete polymer composition), if not explicitly indicated in a different way.

The following methods and techniques are used for testing and characterization of the application properties of produced test samples.

The gloss is measured at 60°, additionally also at 20° or 85°, according to ISO 2813 using a Zehntner ZGM 1120 trigloss Glossmeter (Zehntner GmbH Testing Instruments, Sissach, Switzerland).

The scratch resistance is evaluated by measuring the colour difference (ΔL value) by means of a spectral photometer Spectraflash SF 600 plus (Datacolor AG, Dietlikon, Switzerland). This measurement corresponds to the difference in brightness of the scratched versus the unscratched polymer surface. The scratches are made with the Scratch Hardness Tester 430 P (Erichsen GmbH & Co. KG, Hemer, Germany) similar to GME 60280 (a scratch resistance test according to General Motors Europe Engineering Standard GME 60280, Issue 2, July 2004) with a metal tip of 1 mm diameter (cylindrical hard metal pen with ball-shaped end) and a load of 10 N at room temperature.

The tensile properties are measured according to ISO 527 using a Zwick Z010 universal testing machine (Zwick GmbH & Co. KG, Ulm, Germany) with crosshead speed of 100 mm/min. At least 5 samples are tested for each formulation and average values are calculated. Tensile modulus [MPa], tensile stress at break [MPa] and tensile strain at break [%] are reported.

The flexural properties are measure according to ISO 178 again using a Zwick Z010 universal testing machine. At least 5 samples are tested for each formulation and average values are calculated. Flexural modulus [MPa] and flexural strength [MPa] are reported.

The determination of the Charpy impact energy is performed according to ISO 179/1eA using a Zwick 5113 pendulum impact tester (Zwick GmbH & Co. KG, Ulm, Germany). The work of the hammer is 4 J. Samples are notched prior to the impact test, notch with 0.25 mm radius.

### EXAMPLE 1

### Processing of Injection-Moulded Plaques with TPO (Borealis Daplen ED 012AE) Containing Scripset 550 (Hercules Inc.)

In order to evaluate their surface properties and mechanical properties, a styrene/maleic anhydride copolymer esterified with a low molecular weight sec. butyl ester (Scripset 550, Hercules Incorporated, Wilmington, Del., USA) with typical properties deducible from the following Table 1 is incorporated in TPO injection moulded plaques according to the following procedure:

TABLE 1
Typical Properties of Scripset 550:

| Typical properties | Value | Unit |
|---|---|---|
| Molecular weight, Mw | 105000 | |
| Mw/Mn polydispersity | 2.3 | |
| Glass transition temperature (Tg) | 140-150 | ° C. |
| Acid | 175 | |
| Shelf life | >6 | years |
| Specific gravity | 1.14-1.16 | |
| Softening temperature | 175-180 | ° C. |
| Viscosity @ 25° C., Brookfield, | 6-7 | cps |
| #1, 60 rpm, pH = | | |
| 8.3 (10% solution) | | |

Daplen ED012AE (Borealis AG, Vienna, Austria) in powder form is mixed together with 20% talc (Luzenac A-20; Rio Tinto, Luzenac Europe, Toulouse, France), 2.5% of a carbon black masterbatch, 0.05% calcium-stearate, 0.05% IRGANOX B215 (synergistic antioxidant mixture of a phosphite (tris(2,4-di-(tert)-butyl-phenyl)phosphite and a hindered phenol (tetrakis(methylene-(3,5-di-(tert)-butyl-4-hydrocinnamate))methane, Ciba, Basel, Switzerland), 0.2% TINUVIN 791 FB (UV stabilisator blend of a high and a low molecular weight HALS for synergistic performance in thick section, Ciba, Basel, Switzerland) and 5 or 10% of the melamine cyanurate or the melamine polyphosphate are added as indicated in table 1.

The formulations are mixed in a high speed mixer Mixaco Lab CM 12 (Mixaco, Dr. Herfeld GmbH & Co. KG Maschinenfabrik, Neuenrade, Germany) and compounded at 220° C. to pellets in a twin-screw extruder, e.g. Berstorff ZE 25×33D (KraussMaffei Berstorff GmbH, Hannover, Germany). The pellets are further injection moulded to plaques with a thickness of 2 mm using a standard injection moulding machine, e.g. Engel HL60 (Engel Austria GmbH, Schwertberg, Austria). The processing temperature is around 240° C.

The resulting surface and mechanical properties are summarized in table 2.

TABLE 1

| | | Scratch | Flexural | Flexural | | Charpy |
|---|---|---|---|---|---|---|
| | Gloss | res. ΔL | mod. | strength | Bending | impact |
| | 60° | (10N) | (MPa) | (MPa) | strain (%) | (kJ/m²) |
| Blank | 14.0 | 4.1 | 1488 | 28.2 | 4.0 | 45.9 |
| 2% Scripset 550 | 12.4 | 3.9 | 1339 | 26.5 | 4.2 | 38.0 |
| 3% Scripset 550 | 10.5 | 4.3 | 1264 | 25.8 | 4.3 | 33.1 |

The gloss is reduced by adding the additives without a substantial change of the scratch resistance and the mechanical properties.

### EXAMPLE 2

### Processing of Injection-Moulded Plaques with TPO (Borealis Daplen ED 012AE) Containing Scona Products

The formulations are prepared as described in example 1.

The results are given in table 3

TABLE 3

| | | | | Flexural | |
|---|---|---|---|---|---|
| | Gloss | Scratch res. | Flexural mod. | stregth. | Charpy impact |
| | 60° | ΔL (10N) | (MPa) | (MPa) | (kJ/m²) |
| Blank | 13.3 | 3.5 | 1480 | 28 | 53.3 |
| 5% Scona TSPOE 1112 GBLL | 10.9 | 2.3 | 661 | 19 | 46.0 |
| 5% Scona TSPOE 1002 CMB | 10.5 | 2.4 | 594 | 18 | 47.8 |
| 5% Scona TPPE 2611 PALL | 10.3 | 2.3 | 745 | 19 | 44.8 |
| 5% Scona TPPE 1500 PAL | 12.5 | 3.1 | 896 | 23 | 53.5 |
| 5% Scona TPPP 1616 CMB | 12.8 | 3.3 | 1772 | 29 | 45.2 |
| 5% Scona TPPP 8012 FA | 11.7 | 1.7 | 1615 | 32 | 14.1 |
| 5% Scona TPPP 8112 GA | 11.8 | 2.9 | 1559 | 32 | 13.5 |
| 5% Scona TPPP 8112 FA | 11.2 | 2.4 | 1575 | 32 | 13.1 |
| 5% Scona TPPP 2112 FA | 10.9 | 2.1 | 1725 | 31 | 25.3 |
| 5% Scona TPPP 1400 FA | 9.8 | 3.6 | 1375 | 29 | 31.9 |
| 5% Scona TPSPS 9012 PA | 10.4 | 3.6 | 1705 | 27 | 22.8 |
| 5% Scona TPEV 1112 PB | 13.1 | 2.6 | 1168 | 22 | 49.5 |
| 5% Scona TPEV 5010 PB | 12.9 | 2.8 | 929 | 22 | 49.9 |

The Scona® products are available from KOMETRA GmbH, Schkopau, Germany, and have the properties given in the following table 4:

TABLE 4
Properties of Scona polymers used in Table 3:

| | | | | MFR |
|---|---|---|---|---|
| | | | | (I) (190° C./ |
| | | | | 2.16 kg) |
| | | | | (II) 230° C./ |
| | | | | 2.16 kg) |
| | | Grafted | Graft | (III) 280° C./ |
| | | mono- | level | 1.2 kg) |
| Base Polymer | Modifier Grade | mer | (wt.-%) | g/10 min |
| POE | TSPOE 1112 GBLL | MAH | 1.5 | (I) 6 |
| POE | TSPOE 1002 CMB | MAH | 0.55 | 8 |
| LLDPE | TPPE 2611 PALL | MAH | 6 | (II) 5 |
| LDPE | TPPE 1500 PAL | AA | 5 | (I) 1 |
| PP | TPPP 1616 CMB 6- | styrene | 10 | (II) 35 |
| homopolymer | 4 | | | |
| PP | TPPP 8012 FA | MAH | 0.85 | (I) 80 |
| homopolymer | | | | |
| PP | TPPP 8112 GA | MAH | 0.85 | (I) 90 |
| homopolymer | | | | |
| PP | TPPP 2112 FA | MAH | 1.2 | (I) 6 |
| homopolymer | | | | |
| PP | TPPP 1400 FA | AA | 3 | (II) 3 |
| homopolymer | | | | |
| sPS | TPSPS 9012 PA | MAH | 1.3 | (III) 29-42 |
| EVA | TPEV 1112 PB | MAH | 2 | (I) 4 |
| EVA | TPEV 5010 PB | AA | 4 | (I) 15 |

F = reactor grade
G = granulate
P = powder
CMB = combi master batch (granulate)
MAH = maleic anhydride
AA = acrylic acid
EVA = ethylene vinyl acetate copolymer
MMA = methyl methacrylate
POE = polyolefin elastomer

### EXAMPLE 3

### Processing of Injection-Moulded Plaques with TPO (Borealis Daplen ED 012AE) Containing Scripset 550 and Melamine Polyphosphate (MELAPUR 200, Ciba, Basel, Switzerland))

The formulations are prepared as described in example 1.

TABLE 5

| | | | | Ten- | | | |
|---|---|---|---|---|---|---|---|
| | | | Ten- | sile | | | |
| | | | sile | strain | Flex- | | |
| | | Scratch | mod- | at | ural | Flexural | Charpy |
| | Gloss | res. ΔL | ulus | break | mod. | Strength | impact |
| | 60° | (10N) | (MPa) | (MPa) | (MPa) | (MPa) | (kJ/m²) |
| Blank, | 21 | 4.7 | 1798.5 | 13.2 | 1648.5 | 28.9 | 51.7 |
| 20% talc | | | | | | | |
| 5% | 15 | 5.2 | 1561.9 | 12.1 | 1410.4 | 26.9 | 34.5 |
| MEL- | | | | | | | |
| APUR | | | | | | | |
| 200 FINE | | | | | | | |
| 2.5% | | | | | | | |
| Scripset | | | | | | | |
| 550 resin | | | | | | | |
| 10% | 11 | 5.6 | 1682.8 | 12.4 | 1503.2 | 27.2 | 26.6 |
| MEL- | | | | | | | |
| APUR | | | | | | | |
| 200 FINE | | | | | | | |
| 2.5% | | | | | | | |
| Scripset | | | | | | | |
| 550 resin | | | | | | | |
| 15% | 14 | 5.9 | 1819.8 | 11.6 | 1680.8 | 27.8 | 17.8 |
| MEL- | | | | | | | |
| APUR | | | | | | | |
| 200 FINE | | | | | | | |
| 2.5% | | | | | | | |
| Scripset | | | | | | | |
| 550 resin | | | | | | | |

This shows that also the addition of a melamine derivative together with a modified polymer according to the invention leads to a lower gloss.

### EXAMPLE 4

### Processing of Injection-Moulded Plaques with HCPP (Sabic PP CX02-81)

The formulations are prepared as described in example 1, but instead of Borealis Daplen ED 012AE a high crystalline PP, Sabic PP CX02-81 (polypropylene copolymer plastic, SABIC Deutschland GmbH & Co. KG, Düsseldorf, Germany), is used and no talc is added to the formulations.

The results are shown in the following table 6.

TABLE 6

| | Gloss | Scratch res. |
|---|---|---|
| | 60° | ΔL (10N) |
| Blank, no talc | 52 | 23.5 |
| 2% Scripset 550 | 41 | 23.8 |
| 3% Scripset 550 | 43 | 24.9 |

Thus also with a different polymer substrate lowering of gloss can be found.

### EXAMPLE 5

### Processing of Injection-Moulded Plaques with PC/ABS (Dow Pulse A35-105)

The formulations are prepared as described in example 4, but instead of Borealis Daplen ED 012AE a PC/ABS, Dow Pulse A35-105 (Dow Automotive, Auburn Hills, Mich., USA), is used.

The results are shown in table 7 on the following page.

TABLE 7

| | | | | Tensile | Flex- | | |
|---|---|---|---|---|---|---|---|
| | | Scratch | Tensile | strain | ural | Flexural | Charpy |
| | Gloss | res. | modulus | at break | mod. | Strength | impact |
| | 60° | ΔL (10N) | (MPa) | (MPa) | (MPa) | (MPa) | (kJ/m²) |
| Blank | 51 | 0.3 | 2258 | 44 | 2206 | 71.7 | 38 |
| 2% | 29 | 0.0 | 2001 | 50 | 2224 | 79.1 | 58 |
| Scripset | | | | | | | |
| 550 | | | | | | | |
| resin | | | | | | | |
| 3% | 29 | 0.0 | 2023 | 48 | 2238 | 79.5 | 59 |
| Scripset | | | | | | | |
| 550 | | | | | | | |
| resin | | | | | | | |

### EXAMPLE 6

### Processing of Injection-Moulded Plaques with TPE (Kraiburg STP 9363/33 B 102)

The formulations are prepared as described in example 4, but instead of Borealis Daplen ED 012AE a TPE, Kraiburg STP 9363/33 B 102 (Kraiburg TPE GmbH & Co. KG, Waldkraiburg, Germany) is used (a thermoplastic elastomer).

TABLE 8

| | | | Scratch |
|---|---|---|---|
| | | | resistance |
| | Gloss 20° | Gloss 60° | ΔL (10N) |
| Blank | 48 | 78 | −0.7 |
| 3% Scripset 550 | 28 | 72 | −1.7 |
| 5% Scona TPPP 1400 FA | 42 | 74 | −0.8 |
| 3% IRGASURF SR 100 | 24 | 58 | −1.5 |

In summary, from the Examples it can be deduced that the gloss lowering agents useful according to the invention (chemically modified polymers) are a useful alternative to lower gloss of various different types of polymer and plastics materials in different form, e.g. as fibres, articles of a certain thickness and the like, especially in 3-dimensional articles (not forming films or fibres).

1. A method for reducing the gloss of a polymer article, which method comprises adding a modified polymer to a polymer substrate then forming the article.

2. The method according to claim 1, where the adding of the modified polymer is by melt mixing.

3. (canceled)

4. The method according to claim 1, where the modified polymer is an at least partially esterified form of a polymer having carboxyl groups (—COOH) in the backbone, or is a graft polymer obtained by the reaction of an unsaturated carbonic acid, an ester thereof and/or a vinyl aromatic compound with the backbone polymer of said graft polymer, or is a mixture of two or more of these.

5. The method according to claim 1, where the modified polymer is present in an amount from 0.2 to 40% by weight of the complete polymer mixture.

6. The method according to claim 1, where the polymer substrate into which said modified polymer is added is selected from the group consisting of a styrene comprising polymer, a polyester, a polyamide, a thermoplastic elastomer on urethane basis, poly(styrene)), high impact poly(styrene), a polycarbonate, a polycarbonate/acrylonitrile-butadiene-styrene blend, an acrylonitrile-butadiene-styrene/poly(butylenes terephthalate) blend, poly(vinyl chloride), a poly(vinyl chloride)/acrylonitrile-butadiene-styrene polymer, a poly(vinyl chloride)/acrylonbitrile-styrene-acrylate, an acrylate-modified poly(vinyl chloride), an ionomer, a polyolefin, a thermoplastic elastomer and mixtures of two or more of these polymers.

7. The method according to claim 6, where the polymer substrate is selected from the group consisting of an acrylonitrile-butadiene-styrene polymer, a styrene-butadiene-styrene triblock copolymer, a styrene-acrylonitrile copolymer, an acrylonitrile-acrylate elastomer-styrene copolymer, a poly(butylene terephthalate, a poly(ethylene terephthalate), a poly-1,4-dimethylolcyclohexane terephthalate, a polyhydroxybenzoate, a copolyether ester, polyamide 4, polyamide 6, polyamide 6/6, polyamide 6/10, polyamide 6/9, polyamide 6/12, polyamide 4/6, polyamide 66/6, polyamide 6/66, polyamide 11, polyamide 12, a polyamide based on an aromatic diamine and adipic acid, a polyamide prepared from an alkylene diamine and iso- and/or terephthalic acid or copolyamides thereof, a copolyether amide, a copolyester amide, a thermoplastic elastomer on urethane basis, poly(styrene), high impact poly(styrene), a polycarbonate based on bisphenol A and “carbonic acid” units or other bisphenols and/or dicarbonic acid units as comonomers, a polycarbonate/acrylonitrile-butadiene-styrene blend, an acrylonitrile-butadiene-styrene/poly(butylenes terephthalate) blend, a poly(vinyl chloride); a poly(vinyl chloride)/acrylonitrile-butadiene-styrene polymer, a poly(vinyl chloride)/acrylonbitrile-styrene-acrylate, an acrylate-modified PVC, an ionomer, and a mixture of two or more of these polymer substrates.

8. The method according to claim 6, where the polymer substrate is a polyolefin, a polycarbonate/acrylonitrile-butadiene-styrene blend, an acrylonitrile-butadiene-styrene polymer, a polyamide, or a polyolefin rubber or Thermoplastic Elastomer.

9. The method according to claim 8, where the polymer substrate is polypropylene, polybut-1-ene, poly-4-methylpent-1-ene, polyisoprene, polybutadiene, cyclopentene, norbornene, high density polyethylene, high density and high molecular weight polyethylene, high density and ultrahigh molecular weight polyethylene, medium density polyethylene, low density polyethylene, linear low density polyethylene, a mixture of polypropylene with polyisobutylene or with polyethylene or a mixture of different types of polyethylene, ethylene/propylene copolymers, a propylene/but-1-ene copolymer, a propylene/isobutylene copolymer, an ethylene/but-1-ene copolymer, an ethylene/hexane copolymer, an ethylene/methylpentene copolymer, an ethylene/heptene copolymer, an ethylene/octene copolymer, a propylene/butadiene copolymer, an isobutylene/isoprene copolymer, an ethylene/alkyl acrylate copolymer, an ethylene/alkyl methacrylate copolymer, an ethylene/vinyl acetate copolymer or a copolymer thereof with carbon monoxide, a copolymer of ethylene with propylene and hexadiene, dicyclopentadiene or ethylidene-norbornene; or mixtures of said copolymers with one another or with other polymers mentioned above.

10. The method according to claim 6, where the polymer substrate is a blend of a polyolefin with an ethylene-propylene-diene copolymer, a copolymer of ethylene with higher alpha-olefins, a polybutadiene, a polyisoprene, a styrene-butadiene copolymer, a hydrogenated styrene-butadiene copolymer, a styrene-isoprene copolymer or a hydrogenated styrene-isoprene copolymer.

11. The method according to claim 1, wherein the modified polymer has a backbone which is modified by being grafted with acrylic acid, methacrylic acid, cyanoacrylic acid, maleic acid 2 methyl maleic acid, 2-ethyl-maleic acid, 2-phenyl-maleic acid, 2,3-dimethyl maleic acid, fumaric acid, or an anhydride thereof, and where the grafting may be with more than one of these monomers.

12. The method according to claim 1, where one or more further additives are added to the polymer substrate, said additives being selected from the group consisting of antioxidants, UV absorbers, light stabilizers, metal deactivators, phosphates, phosphonites, hydroxylamines, nitrones, amine oxides, benzofuranones, indolinones, thiosynergists, peroxide scavengers, polyamide stabilizers, basic co-stabilizers, nucleating agents, dispersing agents, plasticizers, lubricants, emulsifiers, pigments, dyes, optical brighteners, rheology additives, catalysts, flow control agents, slip agents, crosslinking agents, crosslinking boosters, halogen scavengers, smoke inhibitors, flameproofing agents, antistatic agents, clarifiers and blowing agents, and where the sum of the relative amounts of the mentioned additives other than nucleating agent in the composition amounts to about 0.01 to about 5% by weight of the complete polymer composition and the amount of the nucleating agent may be up to 40% thereof.

13. (canceled)

14. (canceled)

15. A polymer article, manufactured by a method according to claim 1.
